(19) United States
(12) Patent Application Publication
(10) Pub. No.: US 2021/0206272 A1
(43) Pub. Date: Jul. 8, 2021

(54) SCREEN OPERATING UNIT AND METHOD OF ACTIVATING THE OPERABILITY OF A FUNCTIONAL UNIT OF A MOTOR VEHICLE AND/OR OF ACTIVATING A DEPICTION OF CONTENTS OF A FUNCTIONAL UNIT OF A MOTOR VEHICLE

(71) Applicant: Faurecia Innenraum Systeme GmbH, Hagenbach (DE)

(72) Inventors: Gert-Dieter TUZAR, Hagenbach (DE); Frank URBAN, Stadthagen (DE); Thomas DESSAPT, Stadthagen (DE)

(21) Appl. No.: 17/140,211

(22) Filed: Jan. 4, 2021

(30) Foreign Application Priority Data
Jan. 3, 2020 (DE) 10 2020 100 059.6

(51) Int. Cl. B60K 37/06; G06F 3/0481; G06F 3/0488

(52) U.S. Cl. CPC B60K 37/06; G06F 3/04817; G06F 3/0488; B60K 2370/1438; B60K 2370/119; B60K 2370/115; B60K 2370/111

(57) ABSTRACT

A screen operating unit for a motor vehicle comprises a touch screen an includes two screen areas and an optionally displayable selection area. A functional unit of the motor vehicle can be operated by the screen areas. Alternatively or additionally, graphical contents associated with the functional unit can be depicted. The screen operating unit is configured to make a desired functional unit operable via one of the screen areas and/or to depict graphical contents of the desired functional unit in one of the screen areas. In addition, a method activates an operability of a functional unit of a motor vehicle and/or of activates a depiction of graphical contents associated with the functional unit.

### CROSS-REFERENCE TO RELATED APPLICATIONS

This application is a U.S. non-provisional application claiming the benefit of German Application No. 10 2020 100 059.6, filed on Jan. 3, 2020, which is incorporated herein by reference in its entirety.

### TECHNICAL FIELD

The disclosure relates to a screen operating unit for a motor vehicle, which includes a touch screen. The touch screen comprises a first screen area for operating a functional unit of the motor vehicle and/or for depicting graphical contents associated with the functional unit, and a second screen area for operating a further functional unit of the motor vehicle and/or for depicting graphical contents associated with the further functional unit.

The disclosure likewise relates to a method of activating an operability of a functional unit of a motor vehicle and/or of activating a depiction of graphical contents associated with the functional unit.

### BACKGROUND

Such screen operating units and methods are known from the prior art. It is common practice here to use the different screen areas to operate different functional units of the motor vehicle or to depict graphical contents that are associated with different functional units of the motor vehicle. Examples of functional units are air conditioning units for the interior of the motor vehicle, navigation systems, playback units for media files, for example audio systems, seat adjusters as well as ambient lighting units and scenting units for the interior of the motor vehicle. Further operator-related settings of functional units of the motor vehicle may also be made using such a screen operating unit.

An operator of a motor vehicle, who may be an operator of the screen operating unit at the same time, frequently wishes to replace the functional unit that can be operated by the first screen area with a functional unit that cannot currently be operated by the screen operating unit. If, for example, an operator frequently wishes to change the temperature setting in the vehicle, whereas he regards the seat position as a functional unit that is to be operated rarely, he/she can bring the air conditioning into a screen area as a functional setting and can thus quickly change the air conditioning because it becomes directly selectable, i.e. operable. That is, one of the functional units can only be changed if it is located within one of the screen areas. In other words, the operator wishes to make a different functional unit operable via the first screen area. At the same time, however, a currently existing operability of a functional unit via the second screen area is intended not to be modified. Such change actions frequently require a large number of manual operating steps. These are usually accompanied by a correspondingly large number of depictions on the screen operating unit, which serve in particular to guide the operator of the motor vehicle through various selection menus. This can be comparatively time-consuming and cognitively demanding for the operator and reduces his/her attention to the road traffic.

### SUMMARY

The disclosure provides an improved screen operating unit of the type mentioned at the outset. In this context, in particular, it is intended that the change of functional units of the motor vehicle that are operable using the first screen area or the second screen area can be performed quickly and easily. In particular, the number of manual operating steps and the number of depictions on the screen display unit are intended to be as low as possible. Altogether, this is intended to reduce a cognitive load on the operator of the motor vehicle and to accelerate the change of the functional unit displayed.

In one disclosure, a screen operating unit includes a selection area which is optionally displayable on the screen operating unit and in which a plurality of icons are reproduced which are assigned to functional units of the motor vehicle. Here, the screen operating unit is configured to make the desired functional unit assigned to one of the icons operable via the first screen area or the second screen area and/or to depict graphical contents of the desired functional unit in the first screen area or in the second screen area by moving the icon to the first screen area or the second screen area by at least one operating gesture of a plurality of operating gestures. The icons in the selection area are in particular assigned to functional units that are not currently operable by the screen operating unit and the associated graphical contents of which are not currently depicted by the screen operating unit. This means that a functional unit that is not currently operable using the screen operating unit can be made operable and/or graphical contents of the desired functional unit can be depicted in a simple manner. To do this, it is only necessary to invoke the selection area and to move the icon associated with the desired functional unit to the desired screen area by way of an operating gesture. Preferably, the operating gesture is a drag and drop gesture. The selection area may partly cover the first screen area and/or the second screen area here. Such an operation is quick and intuitive. In addition, the operator is cognitively loaded only to a small extent.

Of course, the touch screen may also comprise three, four or five or more screen areas. In that case, a third screen area is also provided for operating a functional unit of the motor vehicle and/or for depicting graphical contents pertaining to the functional unit. Here, the screen operating unit is configured to make the functional unit assigned to the icon operable for operation via the third screen area and/or to depict graphical contents in the third screen area that pertain to the functional unit assigned to the icon, by moving the icon to the third screen area via an operating gesture. The effects and advantages indicated above are obtained in an analogous manner It will be appreciated, as mentioned, that screen operating units having more than three screen areas are also conceivable.

Preferably, at least two of the screen areas, in particular all screen areas, have different shapes. This allows depictions on the screen operating unit to be designed in a way that is visually appealing to an operator. In this connection, the depictions of the contents of the functional units also need to be different, depending on the screen area selected for them. This also results in a pleasant operating experience for the operator. At the same time, the operator can design the screen operating unit according to his personal preferences by assigning the operability of different functional units to different screen areas.

The selection area may be optionally displayed via an operating gesture. Furthermore, the selection area may be a bar that extends across one or more screen areas, in which icons are depicted or which is formed by icons. Displaying the selection area is thus particularly simple and intuitive. The associated operating gesture is in particular a swipe gesture or a tap gesture. Preferably, in a state in which the selection area is not displayed, a symbol associated with the selection area is displayed at an upper edge of the touch screen. The symbol may be a narrow horizontal bar or line. To invoke the selection area, the aforementioned operating gesture is then applied to this symbol. Thus, for example, the horizontal bar is dragged vertically downward or tapped. The fact that the selection area is a bar results in a high degree of clarity and thus easy operability.

In an alternative embodiment, the selection area may be a vertical bar in which icons are depicted one below the other or which is formed by icons arranged one below the other.

At least one of the screen areas, in particular all screen areas, may have a shape deviating from a rectangle. In this context, boundaries between neighboring screen areas may in particular have a course deviating from a horizontal direction and/or a course deviating from a vertical direction. In other words, the boundaries between neighboring screen areas extend at an angle. This allows the screen operating unit to be designed in a visually appealing manner.

In addition, a method is provided for which in particular the screen operating unit according to the disclosure is used. Here, the operability of a functional unit is possible when one of a plurality of screen areas of a screen operating unit of the motor vehicle is occupied for the functional unit and the depiction of the graphical contents of the functional unit is affected by this screen area. The method comprises the steps of:

(a) invoking a selection area in which a plurality of icons are displayed, which are associated with functional units of the motor vehicle, so that the selection area is displayed on the screen operating unit, and

(b) moving one of the icons to a desired one of the plurality of screen areas via an operating gesture.

In particular, the icons in the selection area are assigned to functional units that are not currently operable using the screen operating unit and the associated graphical contents of which is not currently depicted by the screen operating unit. This means that a functional unit can be made operable quickly and simply using the screen operating unit and/or graphical contents associated with the functional unit can be depicted on the screen operating unit. The cognitive load on an operator is extremely low when carrying out this method.

Advantageously, the selection area is invoked by an operating gesture, in particular wherein a symbol assigned to the selection area is actuated via the operating gesture. As already discussed, the symbol assigned to the selection area may be a bar or line at the upper edge of the screen operating unit. The selection area may be invoked by tapping the symbol or by dragging it vertically downwards. The effects and advantages already mentioned with reference to the screen operating unit are obtained.

The selection area may be automatically hidden after the icon has been moved to the desired screen area. This means that only the two or more screen areas and, if applicable, a symbol for invoking the selection area are then visible on the screen operating unit. This saves the operator an additional operating step, in particular an operating gesture, which serves to hide the selection area. Operation is thus particularly simple.

In addition, a size and/or a shape of at least one screen area, in particular of each screen area, may be adjustable via an operating gesture. In particular, in this connection, the operating gesture can act on boundary areas between neighboring screen areas. Thus, boundary areas can be shifted and/or individual screen areas can be dragged to give them a desired size, for example. This is simple and intuitive.

According to one embodiment, the icons that are displayed in the selection area and are each assigned to a functional unit of the motor vehicle are configured in that, in the displayed state of the selection area, a library in which all functional units of the motor vehicle are represented by icons is invoked via an operating gesture, and at least one selected icon is moved from the library to the selection area or vice versa via a further operating gesture. Alternatively, the icons are configured in that, in the displayed state of the selection area, an arbitrary point of a screen area, by which a functional unit of the motor vehicle is currently operable or in which graphical contents of the functional unit are currently depicted, is moved to the selection area via an operating gesture. In this context, in a state in which the selection area is displayed but the library is not yet displayed, the latter can be invokable via a symbol. The operating gesture for invoking the library is thus applied to this symbol. Here, the symbol is, for example, a narrow horizontal bar or line below the selection area. The operating gesture for invoking the library is preferably a vertical swipe gesture or a tap gesture on the icon representing the library. The operating gesture by which icons are transferred from the library to the selection area or by which icons are transferred from a screen depiction to the selection area is preferably a drag and drop gesture. It should be understood that both the library and the selection area can at least partially overlie the screen areas. It is thus possible to configure the selection area with the personal favorites of an operator in a simple and intuitive way.

To remove an icon from the selection area, the procedure is the other way around. Again, both the selection area and the library are invoked. Then, the icon that is to be removed from the selection area is moved from the selection area to the library using an operating gesture, in particular a drag and drop gesture. As a result, the icon disappears from the selection area.

The library is depicted in particular above or below the selection area.

Preferably, those icons which are depicted in the selection area are merely links or references. This means that those functional units which are represented by icons in the selection area are at the same time represented by icons in the library. Therefore, in the library all functional units are represented by a respectively associated icon at all times.

The selection area may be rendered as a bar with icons arranged side by side, which can be moved by a gesture control in the longitudinal direction of the bar in order to display icons not yet displayed on the screen operating unit and to hide others. In this way, the number of icons that can be depicted in the selection area is, in principle, not limited. At the same time, the icons may be presented within the selection area in a size that is comfortable for an operator, regardless of the size of the screen operating unit. Moving the bar in the longitudinal direction is simple and intuitive.

In an alternative embodiment, the selection area may be rendered as a vertical bar with icons arranged one below the other. The icons can be moved by a gesture control in the longitudinal direction of the bar, i.e. vertically, in order to display icons not yet displayed on the screen operating unit and to hide others.

Generally, the operating gesture is performed, for example, while contacting the touch screen or without contacting the touch screen by sensing hand or finger movements.

### BRIEF DESCRIPTION OF THE DRAWINGS

The disclosure will be explained below with reference to various exemplary embodiments, which are shown in the accompanying drawings.

FIG. 1 shows, in an initial state, a screen operating unit according to the disclosure, by which a method according to the disclosure can be carried out;

FIG. 2 shows the screen operating unit from FIG. 1, with a selection area displayed;

FIG. 3 shows the screen operating unit from FIGS. 1 and 2, with a desired functional unit being made operable;

FIG. 4 shows the screen operating unit from FIGS. 1 to 3 in a target state;

FIG. 5 shows the screen operating unit from FIGS. 1 to 4, with an alternative operating gesture being applied;

FIGS. 6 to 11 show a screen operating unit according to the disclosure, with a selection area being configured according to a first alternative;

FIGS. 12 to 14 show a screen operating unit according to the disclosure, with a selection area being configured according to a second alternative;

FIG. 15 shows a screen operating unit according to the disclosure, with the screen areas being adjusted as regards their size;

FIGS. 16 and 17 show the screen operating unit according to the disclosure in alternative initial states;

FIG. 18 shows an alternative operating element for actuating a screen operating unit according to the disclosure; and

FIGS. 19 to 21 show further states of the screen operating unit according to the disclosure.

### DETAILED DESCRIPTION

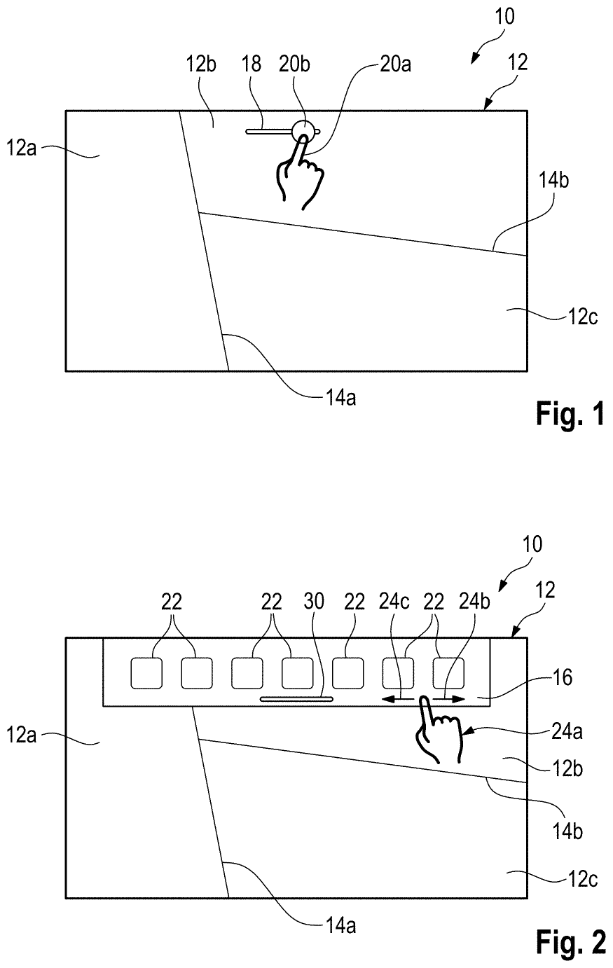

FIG. 1 shows a screen operating unit 10 for a motor vehicle.

It comprises a touch screen 12 having a total of three screen areas 12a, 12b, 12c, where the screen area 12a may also be referred to as first screen area, the screen area 12b as second screen area, and the screen area 12c as third screen area.

The three screen areas 12a, 12b, 12c all have different shapes here, each of which deviates from a rectangle.

In other words, boundaries 14a, 14b between the individual screen areas 12a, 12b, 12c extend neither vertically nor horizontally, i.e. at an angle.

All three screen areas 12a, 12b, 12c are further configured to operate a functional unit of the motor vehicle and/or to depict graphical contents associated with the functional unit.

It will be appreciated that operability is only possible when one of the screen areas 12a, 12b, 12c is occupied for the functional unit and the graphical contents of the functional unit are depicted by this screen area 12a, 12b, 12c.

In this connection, functional units are, for example, air conditioning units, audio systems, seat adjusters or ambient lighting units.

The three screen areas 12a, 12b, 12c are in particular each assigned to different functional units of the motor vehicle here, which, however, is not necessarily so.

In the event that an operator of the screen operating unit 10 wishes to use one of the screen areas 12a, 12b, 12c to make a functional unit of the motor vehicle operable that has so far not been operable via the screen operating unit 10, and/or wishes to depict graphical contents that pertain to a functional unit the graphical contents of which are not currently depicted via the screen operating unit 10, the operator can proceed as follows.

First, he/she invokes a selection area 16 that was not previously visible, by actuating, via an operating gesture, a symbol 18 assigned to the selection area 16.

In the illustrated embodiment, the symbol 18 is a bar arranged centrally at the upper edge of the screen operating unit 10.

The operating gesture is symbolized by a hand 20a and a dot 20b and, in the embodiment illustrated in FIG. 1, is a tapping gesture. The symbol 18 is thus tapped to invoke the selection area 16. Alternatively, the symbol 18 is dragged downward while the touch screen remains touched.

As a result, the selection area 16 is displayed at the upper edge of the screen operating unit 10 (see FIG. 2).

Here, the selection area 16 also has the shape of a bar which extends across the screen areas 12a, 12b, partly covering them.

In the selection area 16, a plurality of icons 22 are reproduced side by side, each of which is assigned to a functional unit of the motor vehicle.

By a gesture control in the longitudinal direction of the bar, symbolized by a further hand 24a and two associated arrows 24b, 24c, icons 22 of the selection area 16 that are not yet displayed on the screen operating unit 10 can be displayed and other icons 22 can be hidden.

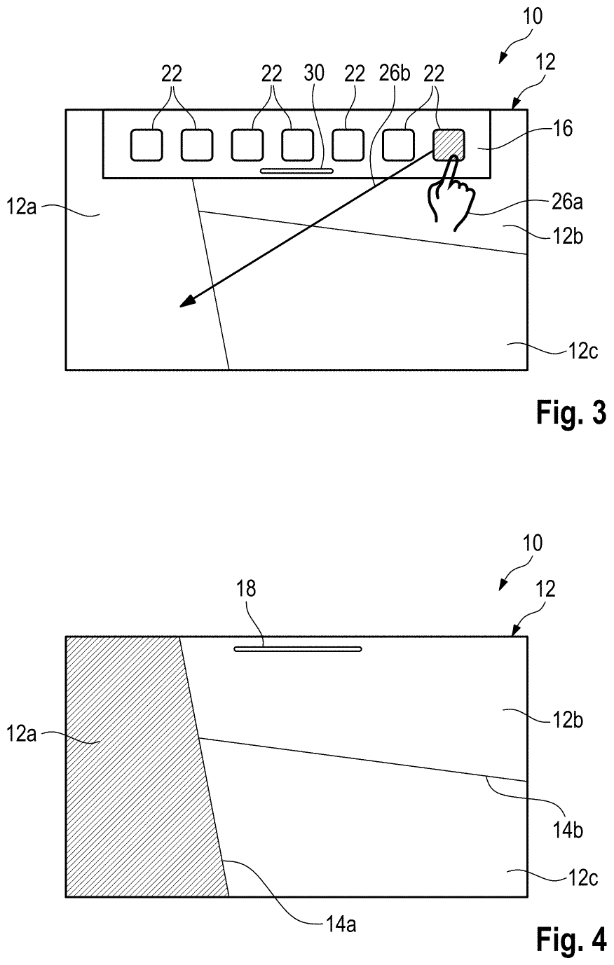

Now, if the operator wishes to make the functional unit that is assigned to the icon 22 illustrated on the far right in FIGS. 2 and 3 operable via the screen area 12a, he/she moves the icon 22 illustrated on the far right in FIGS. 2 and 3 to the screen area 12a via a drag-and-drop gesture. This operating gesture is symbolized by a hand 26a and an associated arrow 26b in FIG. 3.

The selection area 16 is then automatically hidden, so that the target state of the screen operating unit 10 as illustrated in FIG. 4 is obtained, in which the desired functional unit is operable using the screen area 12a and associated contents are displayed in the screen area 12a.

The operability of the functional units assigned to the screen areas 12b, 12c is not modified in this connection. These functional units therefore continue to be operable using the screen areas 12b, 12c.

It will be appreciated that the functional unit assigned to the icon 22 illustrated on the far right in FIG. 3 can be made operable in the same way by using the screen areas 12b or 12c. To do so, the icon 22 merely needs to be moved to the respective screen area 12b, 12c via the operating gesture.

The screen operating unit 10 is thus configured to make the desired functional unit assigned to one of the icons 22 operable via one of the screen areas 12a, 12b, 12c and/or to depict graphical contents of the desired functional unit in one of the screen areas 12a, 12b, 12c.

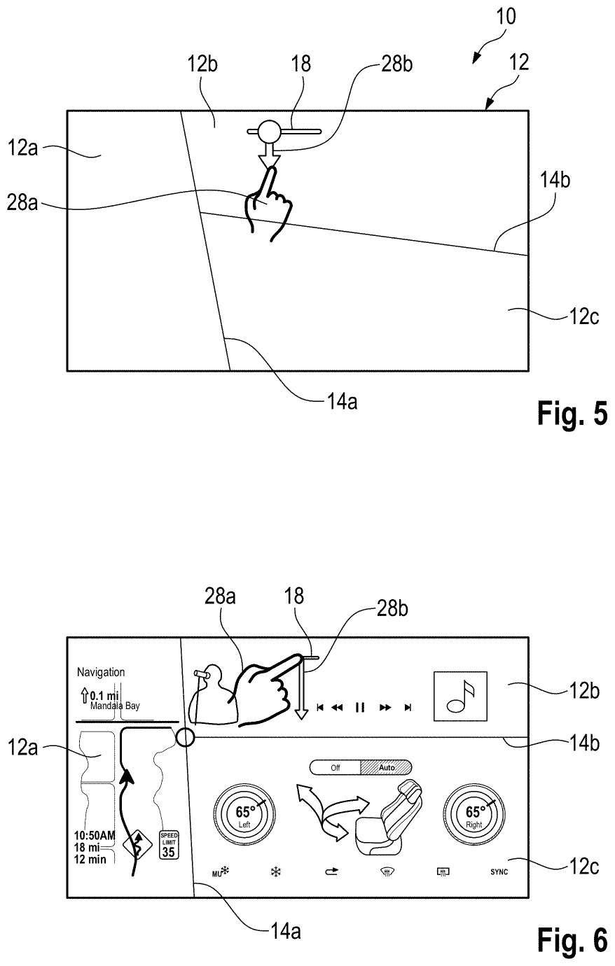

In an alternative embodiment, the selection area 16 is invoked by a swipe gesture, rather than by a tapping gesture (cf. FIG. 1). The symbol 18 is thus drawn vertically downward as part of this swipe gesture. This is symbolized in FIG. 5 by a hand 28a and an associated arrow 28b. Otherwise, the illustration in FIG. 5 corresponds to that in FIG. 1.

The icons 22 displayed in the selection area 16 can be configured by an operator. This will be explained in more detail with reference to FIGS. 6 to 11.

In this connection, FIG. 6 again shows the screen operating unit 10; the screen area 12a can be used to operate a navigation system, the screen area 12b can be used to operate an audio system, and the screen area 12c can be used to operate an air conditioning unit. Furthermore, information associated with the aforementioned functional units is shown in the respective screen areas 12a, 12b, 12c.

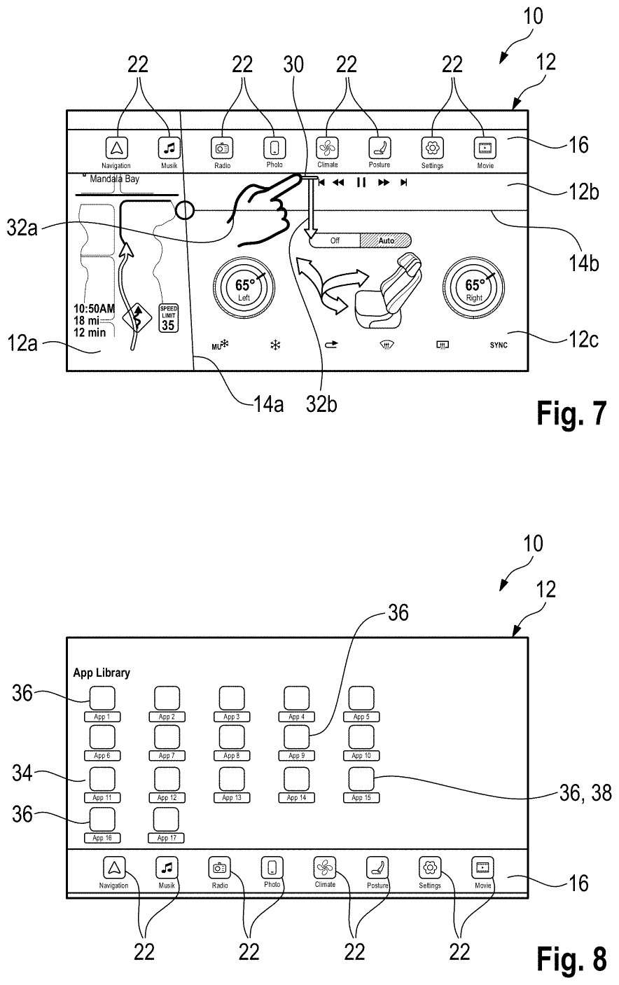

In a first step, the operator opens the selection area 16 via a swipe gesture, which, again, is symbolized by the hand 28a and the arrow 28b. In the selection area 16, icons 22 are again reproduced, which are each assigned to a functional unit of the motor vehicle (see FIG. 7).

In the displayed state of the selection area 16, the operator then invokes a library 34 (see FIG. 8) via a further operating gesture.

To do this, he/she applies the operating gesture, which in the case illustrated in FIG. 7 is a vertical swipe gesture, to a symbol 30 that is assigned to the library 34.

The symbol 30 is again a narrow, horizontally extending bar that is arranged centrally below the selection area 16. The swipe gesture is symbolized by a hand 32a and an arrow 32b in FIG. 7.

In the library 34, all functional units of the motor vehicle are symbolized by icons 36. For the sake of greater clarity, here only some of the icons 36 reproduced in the library 34 are provided with a reference numeral in the Figures.

In the illustrated embodiment, the library 34 is arranged above the selection area 16, the selection area 16 being positioned at a lower edge of the screen operating unit 10 (see FIG. 8).

The screen areas 12a, 12b, 12c visible in the initial state (cf. FIG. 6) are now essentially completely overlaid by the library 34 and the selection area 16.

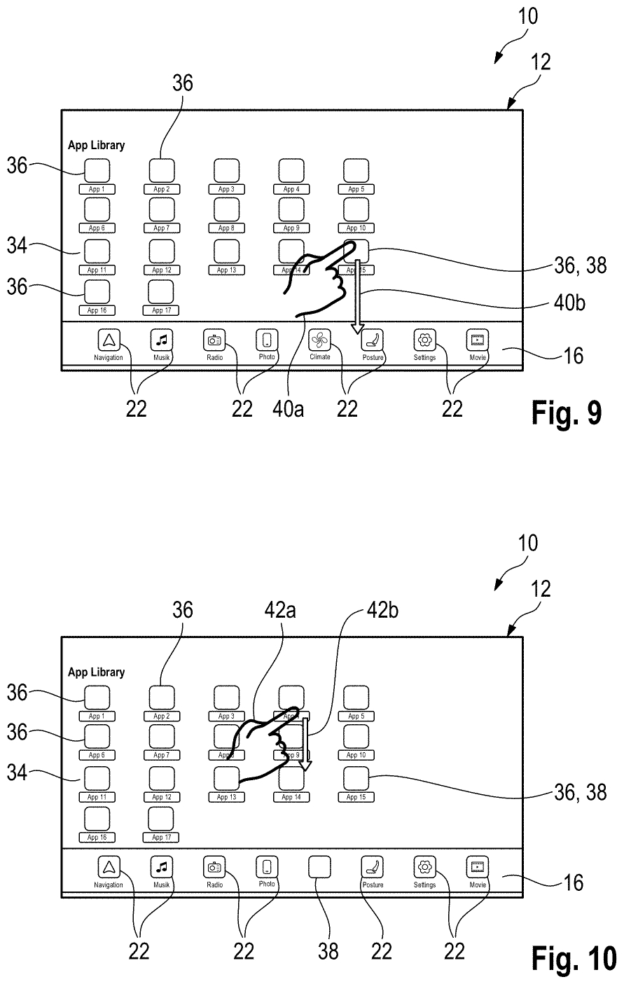

The operator may now, for example, move the icon denoted by 38 of that functional unit which he would like to make invokable via the selection area 16 from the library 34 to the selection area 16 through a further operating gesture (see FIG. 9).

The further operating gesture is a drag and drop gesture symbolized by a hand 40a and an arrow 40b.

The result of this operating step can be seen in FIG. 10, with the icon denoted by 38 now being reproduced in the selection area 16.

In this case, only a reference or a link to the functional unit associated with the icon denoted by 38 is created in the selection area 16. For this reason, the icon denoted by 38 continues to be present in the library 34 in the configuration of the selection area 16.

It should be understood that the operator can similarly move still further icons 36 from the library 34 to the selection area 16 via the operating gesture symbolized by the hand 40a and the arrow 40b.

When the operator wishes to terminate the configuration of the selection area 16, he/she can close the library 34 via a vertical swipe gesture that is symbolized by a hand 42a and an arrow 42b (see FIG. 10).

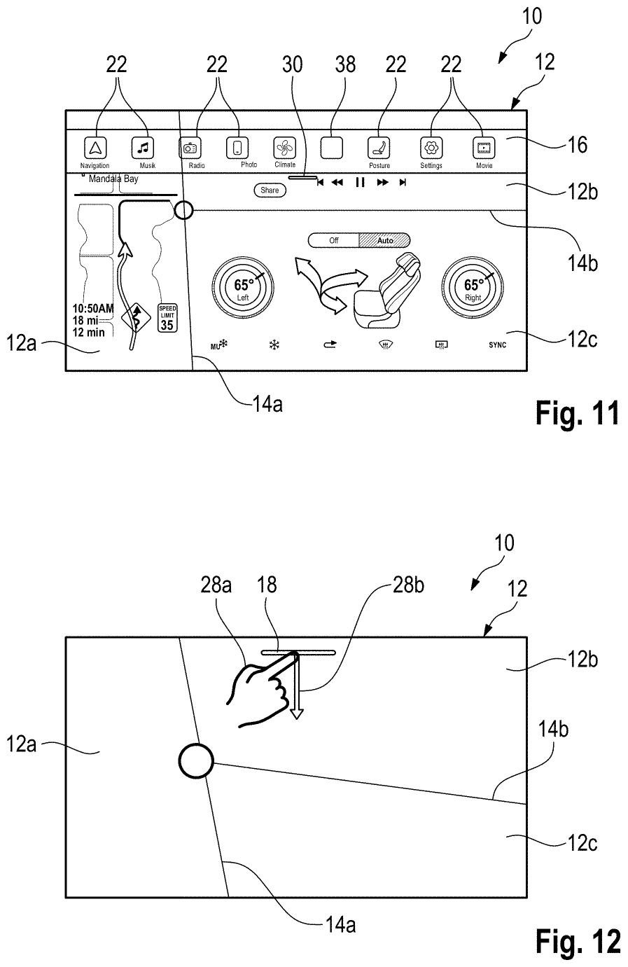

The selection area 16 then moves back to the upper edge of the screen operating unit 10 (see FIG. 11).

The operator has thus changed the state illustrated in FIG. 7 to the effect that the icon 38 is now also available in the selection area 16.

The screen areas 12a, 12b, 12c are now at least partly visible again.

Removing an icon 22 from the selection area 16 is carried out in an analogous manner. To this end, the selection area 16 and the library 34 are again displayed simultaneously. The icon 22 to be removed is then moved to the library 34 using a drag and drop gesture and disappears from the selection area 16 in the process.

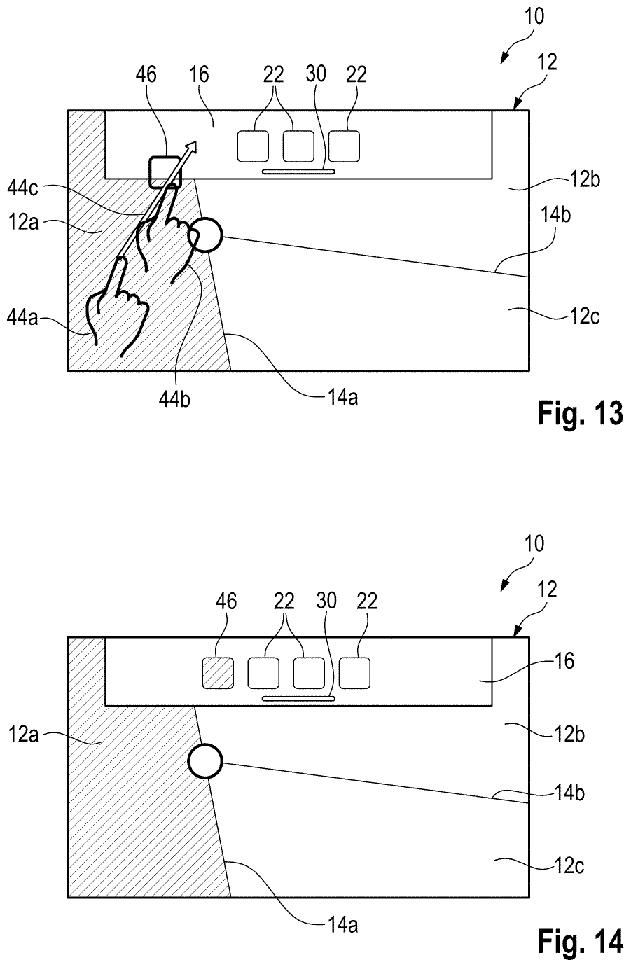

FIGS. 12 to 14 show an alternative procedure for the configuration of the selection area 16 with respect to the icons 22 reproduced there.

Here, the initial state illustrated in FIG. 12 corresponds to the initial state from FIG. 6.

Again, the selection area 16 is displayed via the vertical swipe gesture symbolized by the hand 28a and the arrow 28b. Using the screen areas 12a, 12b, 12c, functional units of the motor vehicle can again be operated, which correspond, for example, to the functional units illustrated in FIG. 6.

The operator can now move any desired point of the screen area 12a to the selection area 16 via an operating gesture that is symbolized by the two hands 44a, 44b and the arrow 44c. Here, the two illustrated hands 44a, 44b in reality relate to one single hand, which, however, is symbolically depicted at different points in time of the execution of the gesture.

The operating gesture is a drag and drop gesture here.

In this way, an icon 46 that is assigned to the functional unit of the motor vehicle currently operable via the screen area 12a is generated and reproduced in the selection area 16.

Furthermore, the screen areas 12a, 12b, 12c can be adjusted in terms of their sizes and shapes using operating gestures. To do so, it is only required to shift the boundaries 14a, 14b.

The screen operating unit 10 can be configured in accordance with the preferences of an operator in this way as well.

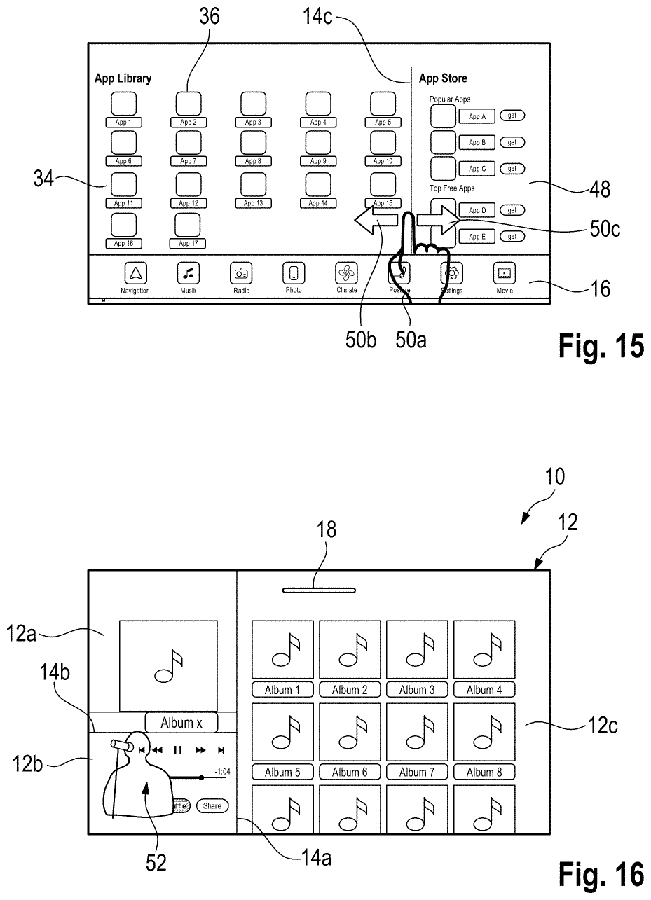

Such an adjustability of the size is also given for the library 34 and an app store 48 possibly represented concurrently (see FIG. 15). In this context, a boundary 14c between the library 34 and the app store 48 is also shifted via an operating gesture that is symbolized by a hand 50a and two arrows 50b, 50c (see FIG. 15).

FIG. 16 shows the screen operating unit 10 in an alternative initial state.

Here, all screen areas 12a, 12b, 12c are occupied by depictions of an audio system; compared to the depictions in FIGS. 1 to 15, the boundaries 14a, 14b between the screen areas 12a, 12b, 12c also extend differently.

The screen area 12a now comprises a representation of a cover picture of a currently playing music album.

The screen area 12b shows an image of the associated artist. It is overlaid by operating buttons 52 of the audio system.

The operating buttons 52 can be actuated by touching the touch screen 12.

In the screen area 12c, an audio library including various cover pictures of available audio albums can be seen.

It will be appreciated that the assignment of the individual depictions to the screen areas 12a, 12b, 12c is variable. It is thus possible, in particular, to depict the operating buttons 52 and the artist's image located behind them in the screen areas 12b, 12c as well.

Proceeding from this initial state, the selection area 16 can be displayed again by actuating the symbol 18. Reference is made to the above explanations in this respect.

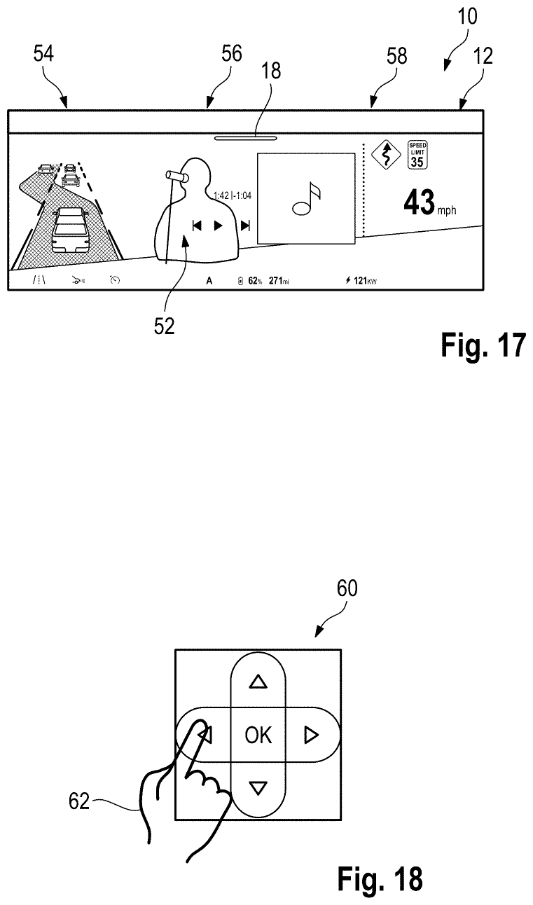

A further alternative initial state of the screen operating unit 10 is illustrated in FIG. 17.

The screen areas are now clearly different from the screen areas shown in the preceding Figures.

Now, a left-hand screen area 54 can be used to operate a navigation system, and a middle screen area 56 can be used to operate an audio system. In a right-hand screen area 58, information regarding a driving speed is presented.

Here, again, the operating buttons 52 of the audio system overlie an image of the artist in the middle screen area 56.

Proceeding from this initial state, the selection area 16 can again be displayed by an actuation of the symbol 18. Reference is made to the above explanations in this respect.

Although the screen operating unit 10 comprises a touch screen 12, it may alternatively or additionally be actuated via an operating element 60 arranged spaced apart from the screen operating unit 10.

The operating element is, for example, in the form of a directional pad having a central acknowledgment key. An actuation of the operating element 60 is symbolized by a hand 62 (see FIG. 18).

The operating element 60 is adapted to be mounted to a steering wheel, for example.

An actuation of the screen operating unit 10 by such an operating element 60 is of advantage in particular when the motor vehicle in which the screen operating unit 10 is mounted is operated autonomously.

In such a mode of operation, an operator can choose his/her seating position in the motor vehicle relatively freely, so that it may possibly not be convenient for him/her to reach the touchscreen 12. The operating element 60, by contrast, may be easily accessible in such a seating position, so that it is more convenient for the operator to actuate the screen operating unit 10 via the operating element 60.

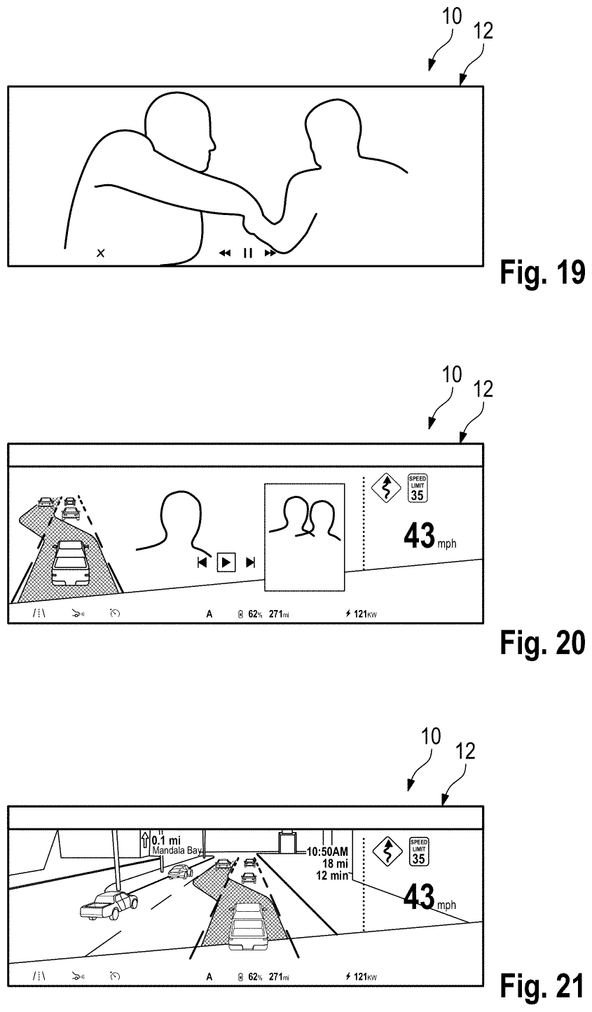

An exemplary case of application of the operating element 60 is illustrated in FIGS. 19 to 21.

Here, the reproduction of an entertainment program can be seen on the touch screen 12 in a full-screen presentation in FIG. 19. Thus, the operator can watch an entertainment program, e.g. a movie, during an autonomous travel of the motor vehicle, utilizing the entire size of the touch screen 12.

In the event that he/she wishes to receive information on the current trip during this time, he/she can conveniently retrieve it via the operating element 60. Ideally, it is not necessary for him/her to change his/her seating position for this purpose.

In this context, he/she can invoke the representation from FIG. 20, for example, by actuating the operating element 60, or more precisely by actuating the left arrow key of the operating element 60 (see hand 62 in FIG. 18). In this representation, the operator receives information on other available entertainment programs as well as on the currently ongoing autonomous drive of the motor vehicle.

Likewise, by actuating the operating element 60, he/she can arrive at the representation according to FIG. 21, in which the operator is being fully informed about the currently ongoing autonomous drive. To do this, he/she actuates the right arrow key of the operating element 60, for example. Information about the entertainment program is now no longer visible on the touch screen 12.

It is understood that the representations from FIGS. 20 and 21 are merely exemplary and that they can be reached starting from the representation of FIG. 19 either directly or via one or more intermediate representations.

This functionality allows an operator, on the one hand, to make use of an extensive entertainment program and, on the other hand, to quickly and simply obtain desired information regarding the autonomous driving.

Furthermore, the screen operating unit 10 may be equipped with a voice unit, not illustrated in more detail, via which an actuation step, which comprises, for example, an operating gesture or an interaction with the operating element 60, is confirmed by a voice output.

Further, a voice output provided by the voice unit may comprise a prompt to an operator of the motor vehicle.

In addition, the voice unit may be configured to actuate the screen operating unit 10 via voice commands The voice unit may thus be used as an alternative to the input using the touch screen 12.

Although various embodiments have been disclosed, a worker of ordinary skill in this art would recognize that certain modifications would come within the scope of this disclosure. For that reason, the following claims should be studied to determine the true scope and content of this disclosure.

1. A screen operating unit for a motor vehicle, comprising a touch screen having:
a plurality of screen areas including at least a first screen area and a second screen area, the first screen area to operate a functional unit of the motor vehicle and/or to depict graphical contents associated with the functional unit;
the second screen area to operate a further functional unit of the motor vehicle and/or to depict graphical contents associated with the further functional unit;
a selection area which is optionally displayable on the screen operating unit and in which a plurality of icons are reproduced which are assigned to functional units of the motor vehicle,
wherein the screen operating unit is configured to make a desired functional unit assigned to one of the plurality of icons operable via the first screen area or the second screen area and/or to depict graphical contents of the desired functional unit in the first screen area or in the second screen area by moving the one of the plurality of icons to the first screen area or the second screen area via at least one operating gesture of a plurality of operating gestures.

2. The screen operating unit according to claim 1, wherein at least two of the plurality of screen areas have different shapes.

3. The screen operating unit according to claim 2, wherein all screen areas of the plurality of screen areas have different shapes.

4. The screen operating unit according to claim 1, wherein the selection area is optionally displayed upon detection of the at least one or another operating gesture of the plurality of operating gestures, and wherein the selection area is a bar that extends across one or more screen areas of the plurality of screen areas, in which the plurality of icons are depicted or which is formed by the plurality of icons.

5. The screen operating unit according to claim 1, wherein at least one of the plurality of screen areas have a shape deviating from a rectangle.

6. The screen operating unit according to claim 5, wherein all screen areas of the plurality of have a shape deviating from a rectangle.

7. A method of activating an operability of a functional unit of a plurality of functional units of a motor vehicle and/or of activating a depiction of graphical contents associated with the functional unit, the operability of the functional unit being possible when one of a plurality of screen areas of a screen operating unit of the motor vehicle is occupied for the functional unit and the depiction of the graphical contents of the functional unit is effected by the one of the plurality of screen areas, the method comprising the steps of:
(a) invoking a selection area in which a plurality of icons are displayed, which are associated with the plurality of functional units of the motor vehicle, so that the selection area is displayed on the screen operating unit , and
(b) moving one of the plurality of icons to a desired one of the plurality of screen areas via at least one operating gesture of a plurality of operating gestures.

8. The method according to claim 7, wherein the selection area is invoked by the at least one or another operating gesture of the plurality of operating gestures.

9. The method according to claim 8, wherein a symbol assigned to the selection area is actuated by the at least one or another operating gesture of the plurality of operating gestures.

10. The method according to claim 7, wherein the selection area is automatically hidden after the one of the plurality of icons has been moved to the desired one of the plurality of screen areas.

11. The method according to claim 7, wherein a size and/or a shape of at least one screen area of the plurality of screen areas is/are adjustable by the at least one or another of the plurality of operating gestures.

12. The method according to claim 7, wherein the plurality of icons that are displayed in the selection area, and which are each assigned to a respective functional unit of the plurality of functional units, are configured in that, in a displayed state of the selection area, a library in which all the plurality of functional units of the motor vehicle are represented by the plurality of icons is invoked by the at least one or another operating gesture of the plurality of operating gestures, and at least one selected icon of the plurality of icons is moved from the library to the selection area or vice versa by another operating gesture of the plurality of operating gestures.

13. The method according to claim 7, wherein the plurality of icons that are displayed in the selection area, and which are each assigned to a respective functional unit of the plurality of functions units, are configured in that, in a displayed state of the selection area, an arbitrary point of a screen area of the plurality of screen areas, by which a functional unit of the plurality of functional units is currently operable or in which graphical contents of the functional unit are currently depicted, is moved to the selection area via the at least one or another operating gesture of the plurality of operating gestures.

14. The method according to claim 7, wherein the selection area is rendered as a bar with the plurality of icons arranged side by side, which can be moved by a gesture control in a longitudinal direction of the bar in order to display icons from the plurality of icons not yet displayed on the screen operating unit and to hide other icons from the plurality of icons.

15. The method according to claim 7, wherein the screen operating unit for the motor vehicle is used for conducting the method, comprising a touch screen having
a first screen area of the plurality of screen areas to operate the functional unit of the motor vehicle and/or to depict graphical contents associated with the functional unit,
a second screen area of the plurality of screen areas to operate a further functional unit of the motor vehicle and/or to depict graphical contents associated with the further functional unit,
the selection area which is optionally displayable on the screen operating unit and in which the plurality of icons are reproduced which are assigned to the plurality of functional units of the motor vehicle,
wherein the screen operating unit is configured to make a desired functional unit assigned to one of the plurality of icons operable via the first screen area or the second screen area and/or to depict graphical contents of the desired functional unit in the first screen area or in the second screen area by moving the one of the plurality of icons to the first screen area or the second screen area via an operating gesture.
